(19) United States
(12) Patent Application Publication
(10) Pub. No.: US 2007/0050851 A1
(43) Pub. Date: Mar. 1, 2007

(54) Information processing apparatus and information processing method

(76) Inventors: Yoshinori Musha, Sagamihara (JP); Koichi Terada, Kamakura (JP); Mutsumi Shimoda, Kawasaki (JP); Keita Ito, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/432,506

(22) Filed: May 12, 2006

(30) Foreign Application Priority Data
Aug. 30, 2005 (JP) 2005-248580

(51) Int. Cl. H04L 9/32; G06F 17/30

(52) U.S. Cl. 726/27

(57) ABSTRACT

An information processing apparatus for realizing coexistence of a high-speed editing function for contents whose copyright is protected and a defending function for limitless movement due to alteration of the contents and a defending function for an illegal process using power-off. When the contents constructed on a block unit basis is received and division-edited, block unique information as unique information corresponding to each divided block is formed. Apparatus unique information to specify the apparatus is recorded into a memory or the like. A Hash value which is formed from the formed block unique information and the apparatus unique information which has previously been stored in the memory or the like is stored.

### INCORPORATION BY REFERENCE

The present application claims priority from Japanese application JP2005-248580 filed on Aug. 30, 2005, the content of which is hereby incorporated by reference into this application.

### BACKGROUND OF THE INVENTION

The invention relates to information processing apparatus and method for inhibiting illegal alteration and copy in storage of contents as a copyright protection target or in reproduction, edition, and movement of the stored contents and also relates to a program recording medium.

In recent years, a copy control technique to protect digital contents having a copyright has been 10 used in a digital information apparatus which can easily handle the digital contents such as motion image or music/audio sound or in a medium for recording the digital contents.

In JP-A-2000-306328, there has been disclosed a technique in which all contents data is encrypted by a title key for encrypting the whole contents and stored in a hard disk, file names, an encrypted encryption key, and reproducing conditions of all of the contents data stored in the hard disk are stored into management information of the contents data, a Hash value of the whole management information is calculated and stored in an EEPROM, and prior to storing the contents or executing a moving process, the Hash value of the whole management information is calculated and compared with the preceding Hash value which has been stored in a non-volatile memory, and if they do not coincide, the process is inhibited by deciding that the contents data has been altered.

In JP-A-2003-272289, there has been disclosed a technique in which the whole copy-once contents is encrypted by using a title key, in the contents information, an area which has already been moved is discriminated, reproduction-possible conditions including reproducible area information showing areas which can be reproduced from now on are formed and stored into a hard disk, the reproduction-possible conditions are updated every minute, and after a Hash arithmetic operation is executed, a Hash value is recorded into an EEPROM.

### SUMMARY OF THE INVENTION

Particularly, in an information apparatus which handles, contents of a large capacity such as a video image, it is important to enable the user to execute the stressless high-speed editing operation in a range of a personal use of a copyright law by a high-speed editing function mainly including the division and coupling of contents.

In JP-A-2000-306328 and JP-A-2003-272289, the title key is used as an encryption key for encrypting the whole of one contents. That is, any portion in the contents depends on the title key unique to the contents. Therefore, for example, even in the case of coupling two contents into one contents by the editing operation, it is necessary to decrypt one contents by the title key thereof, thereafter, encrypt the decrypted contents again by the title key of a coupling destination, and couple them.

Similarly, in the case where the contents is divided by the editing operation and another contents different from the original contents is formed, it is necessary that the portion to be separated from the original contents is decrypted by the original title key, a title key for such another contents is newly formed, and such a portion is encrypted again by using the new title key. In the contents of a large capacity such as a video image, if a capacity of the portion to be separated is large, it takes a very long time to decrypt and encrypt again, so that the high-speed editing function cannot be provided for the user.

It is also necessary to prevent such an illegal process that a copyright protecting function provided for the information apparatus is invalidated by turning off a power source during a data process. For example, if the power-off is caused just before the end of the moving process and the apparatus is reactivated in the state before information showing the completion of the movement is recorded, the whole of the contents most of which has already been moved enters the movable state again, and many copies are formed by repeating the movement.

In JP-A-2003-272289, the illegal process using the power-off is prevented by calculating the Hash value every minute and recording the Hash values into the EEPROM as mentioned above. However, there is such a problem that the coexistence with the foregoing high-speed editing function is impossible and, it is permitted to reproduce again the area of up to one minute just after the reproduction.

The shorter a recording time interval of the Hash values is, the shorter a time to permit the illegality can be. However, such a permitting time cannot be set to zero in principle and there is a life of a non-volatile memory as an upper limit of the number of rewritable times. There is a possibility of causing such a situation that the life of the non-volatile memory expires before the end of the presumed product life of the information apparatus. Although the non-volatile memory in which the number of rewritable times is larger than that of the EEPROM has already been developed, such a memory is not spread at present and an increase in costs of the product is caused.

The invention is made in consideration of the foregoing problems and intends to effect the copyright protection. Specifically speaking, the invention relates to the coexistence of the high-speed editing function and the defending function of the endless movement due to the alteration of the contents and to the realization of the defending function of the illegal process using the power-off.

To solve the above problems, for example, the following construction can be used.

When contents constructed on a block unit basis is received, divided, and edited, block unique information as unique information corresponding to each of the divided blocks is formed. It is sufficient to control in such a manner that apparatus unique information for specifying an apparatus is recorded into a memory or the like and a Hash value which is formed from the formed block unique information and the apparatus unique information which has preliminarily been stored in the memory or the like is stored.

The block unique information may be encryption key data of the block of the contents, data in which the encryption key of the block has been further encrypted, encryption key seed data including random numbers serving as an origin to form the encryption key of the block, or data including them in a part.

The apparatus unique information may be not only information for one apparatus but also unique information for a group of a plurality of apparatuses. For example, if there are three PCs in a home, the apparatus unique information may be common unique information for specifying the three PCs. By using such apparatus unique information, re-encryption and contents re-signature become unnecessary and use convenience in the range of the personal use in the home is improved.

The Hash value which is formed by using the block unique information and the apparatus unique information may be obtained in or out of the apparatus. It may be a feature of the present invention that the block unique information is used without using the unique information unique to the whole contents and that a copyright protecting mechanism (technique such as signature or authentication) is coupled with such a construction.

According to the invention, the copyright protection can be effected.

Other objects, features and advantages of the invention will become apparent from the following description of the embodiments of the invention taken in conjunction with the accompanying drawings.

### BRIEF DESCRIPTION OF THE DRAWINGS

FIG. 1 shows an embodiment explaining response to breakdown of a non-volatile memory;

FIG. 2 is a constructional diagram of a module for explaining the embodiment of the invention;

FIG. 3 is a PAD diagram for a terminal process when seen from a viewpoint of a copyright protecting function;

FIG. 4 shows the embodiment of the invention explaining a writing process of contents;

FIG. 5 shows the embodiment of the invention explaining a contents signature;

FIG. 6 shows the embodiment of the invention explaining contents authentication;

FIG. 7 shows the embodiment of the invention explaining a reading process of the contents;

FIG. 8 shows the embodiment of the invention explaining contents division;

FIG. 9 shows the embodiment of the invention explaining contents coupling; and

FIG. 10 shows the embodiment of the invention explaining a recovery process after abnormal end.

### DETAILED DESCRIPTION OF THE INVENTION

An embodiment of the invention will be described hereinbelow with reference to the drawings.

FIG. 2 is a constructional diagram of a module for explaining the embodiment of the invention. Reference numeral 201 denotes a terrestrial digital broadcast receiving apparatus (terminal). The terminal 201 receives contents from a terrestrial digital broadcast or the Internet and has an editing function mainly including the division and coupling of the contents besides recording and reproduction thereof and records the contents into a recording media. Each module is connected through a bus 204 and a processor 206 executes a process of data and controls each module in accordance with a program which has been loaded into a volatile memory 208 from a storing device 209 of a large capacity. Reference numeral 202 denotes a terrestrial digital broadcasting module constructed in such a manner that a radio wave from a UHF antenna 211 or a coaxial cable of a cable TV broadcast is received and a desired channel is selected by a TV tuner function provided in the broadcasting module 202, data of a digital broadcast which has been encrypted by a MULTI2 system is decrypted, an audio/video recording process is executed, the digital data is converted into a physical signal by an audio/video output function provided in the module 202, and the physical signal is outputted to a display/speakers 203. Although not shown, the terrestrial digital broadcasting module 202 also has a connecting terminal to a BCAS card to form an encryption key for decrypting the MULTI2 encryption. A non-volatile memory 210 is connected to the terrestrial digital broadcasting module 202. Information for storing session information of the recording, reproduction, or the like is stored into the area on the non-volatile memory which cannot be directly accessed from the outside such as a bus 204 or the like and information to make authenticity confirmation (alteration detection) of a contents unit is stored in the non-volatile memory 210.

The encryption for video recording is executed at the time of the recording or the like of the contents data. The encryption, the creation of the encryption key which is used for the encryption, and the creation of the encryption key seed data which is used to form the encryption key are executed by the processor 206. The creation of the encryption key seed data is executed by using a random number generating function. The creation of the encryption key is executed by Hash arithmetic operating the information such as encryption key seed data, terminal unique information, or the like.

The Hash arithmetic operation is also used for the signature and authentication of the contents. The Hash arithmetic operation is executed to the terminal unique information and the contents unique information with respect to all of the data of the content or all of the data (encryption key seeds) serving as an origin (seeds) for decrypting the blocks of the content. A value which is outputted as a result of the Hash arithmetic operation is used as a contents authentication value. The operation to store the contents authentication value into the non-volatile memory is defined as “contents signature”. The operation to discriminate whether or not the contents authentication value which is read out of the non-volatile memory coincides with the contents authentication value which is similarly formed from the contents serving as a target of the alteration confirmation is defined as “contents authentication”.

Although a method having such a nature called “encryption Hash algorithm” that (1) it is difficult to presume the original data from the Hash value and (2) it is difficult to form another data having the same Hash value should be used in the Hash arithmetic operation mentioned here, the arithmetic operation by another method is not excluded. It is also possible to construct the apparatus in such a manner that the Hash arithmetic operating method is made secret, thereby disabling the method of the Hash arithmetic operation which is executed in the apparatus to be known.

In the case of recording, the encryption for recording is further executed to the reception data, the encrypted data is transferred to the volatile memory 208, and thereafter, it is recorded into the storing device 209 of the large capacity on a contents unit basis. The data which is recorded can be stored into the storing device 209 of the large capacity from the Internet through a communication I/F (interface) 205.

In the case of reproduction, the data is transferred to the volatile memory 208 from the storing device 209 of the large capacity, converted into an audio/video by the terrestrial digital broadcasting module 202, and outputted as images/audio sound onto/from the display/speakers 203. In this instance, the encryption for recording is decrypted.

In the case of the edition mainly including the division and coupling of the contents, a part of the contents data in the storing device 209 of the large capacity is loaded into the volatile memory 208, divided or coupled, and thereafter, returned to the storing device 209 of the large capacity. As necessary, the data is transmitted and received to/from the terrestrial digital broadcasting module.

In the case of the moving process for moving the data of a moving source side in such a form that the existence of the copy of the copy-once contents is not permitted by erasing or disabling reproduction of the data, after the encryption for the media is executed to the recording data in the storing device 209 of the large capacity, the encrypted data is moved to an optical recording media such as recordable DVD, blu-ray disc, or the like or to a semiconductor recording media such as an SD card or the like by a media control module 207. The encrypted data is also transmitted to another terminal connected to the Intranet (home network) through the communication I/F 205.

The communication I/F 205, volatile memory 208, and the like are controlled by the processor 206. For example, the downloading or stream reception of a file of the purchased broadband contents can be realized by accessing a WWW site, and the transfer of the contents to the home network can be enabled.

A session managing function of managing sessions such as recording, reproduction, edition, and the like is realized by the terrestrial digital broadcasting module 202 or the processor 206. Prior to starting the session, the session information is stored into the non-volatile memory 210 or the like. The session key seed which is formed by the random number generating function and the kind of session which means an action mode such as recording, reproducing or the like, ID of the contents as an operation target, operation start time, and the like are included in the session information. The session managing function is a function for reading out the information of the previous session after reactivation and enabling a restoring process in the case where the session has been interrupted by an abnormal situation such as a power-off or the like. Also in the case where the data has been altered during the power-off state, it can be detected.

By the foregoing module construction, the recording, edition, reproduction, and the like of the broadcast contents of the terrestrial digital broadcast or the like or the digital contents downloaded through the Internet can be performed, and the data alteration is prevented by the encryption, thereby making the copyright protection.

The encryption and decryption for recording of the contents data, the creation of the encryption key which is used for the encryption, the contents signature process, the authenticating process, and the like may be also executed in the terrestrial digital broadcasting module 202 instead of the processor 206. In this case, since the contents data and the encryption key data which are not encrypted are not supplied to the bus 204, the illegal decoding of the encrypted data by analyzing the signal on the bus 204 can be defended and a degree of copyright protection can be raised.

The data recording into the storing device of the large capacity such as recording of the broadcasting contents, storage of the data after the edition of the contents, or the like is expressed as “write (or writing)” hereinbelow. Similarly, the extraction of the data from the storing device of the large capacity such as reproduction of the recorded contents, extraction of the data as an editing target, or the like is expressed as “read (or reading)” hereinbelow.

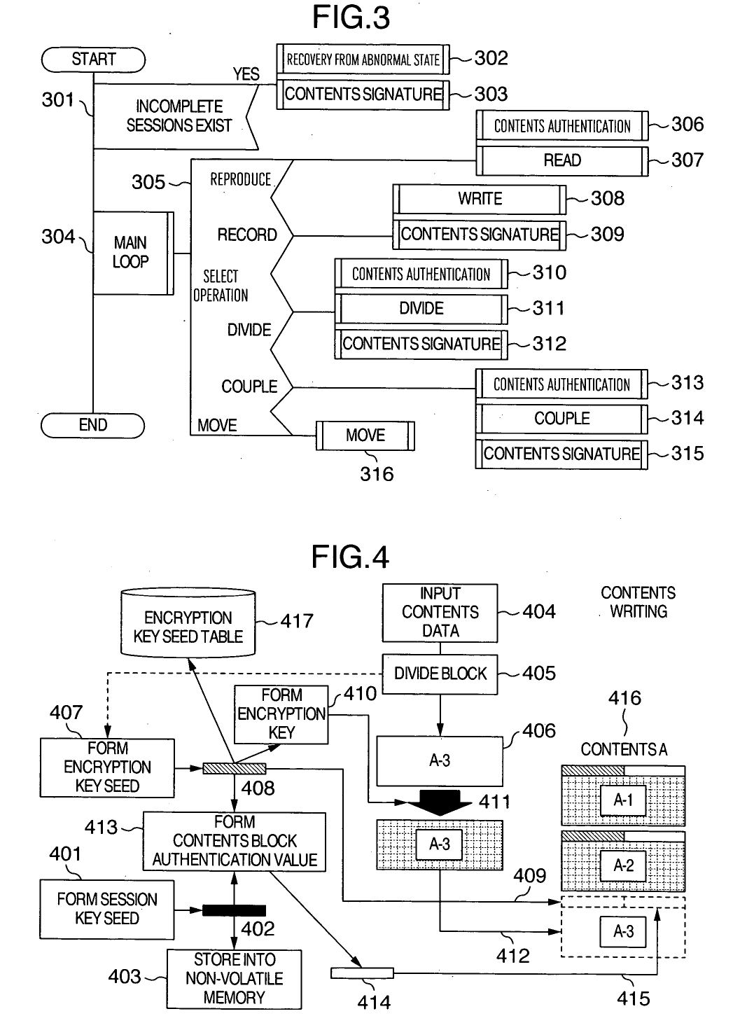

FIG. 3 is a PAD diagram for a terminal process (from a viewpoint of the copyright protecting function) describing the embodiment of the invention. When the terminal is activated, first, in 301, the session information in the non-volatile memory is read out and the existence of the incomplete session is confirmed. If it exists, this means that the process was not normally finished at the previous time but has been interrupted on the way of the session for processing the contents. Therefore, the contents writing process is recovered from abnormal state in 302. The recording of the authentication value of the contents for the alteration detection is executed by the contents signature in 303, thereby completing the session. Reference numeral 304 denotes a main loop for waiting for the operation of the user through a user interface during the activation of the terminal. When the terminal is operated, the operation is selected in 305.

In the case of reproduction in 305, the alteration detection is performed in the contents authentication of the recorded data in 306. If the alteration is not performed, the contents is read out in 307 and the contents is reproduced.

In the case of recording in 305, the encryption of the reception contents and the writing into the storing device of the large capacity are performed in the writing of the contents in 308. The contents signature is made in 309 and the apparatus enters the contents readable state.

If the division of the editing operation is selected in 305, the contents authentication is made in 310. If the contents is not altered, the dividing process of the contents is executed in 311. The contents signature is made in 312.

If the coupling in the editing operation is selected in 305, the contents authentication is made in 313. If the contents is not altered, the coupling process of the contents is executed in 314. The contents signature is made in 315.

If the movement is selected in 305, the contents data is moved to the recording media by the media control in FIG. 2. If the original data has been moved, a process (erasure of the contents or erasure of the encryption key seed) for disabling a range which does not exceed one minute to be read out is executed during the moving process. After completion of the moving process, the information regarding the contents such as contents authentication value and the like is erased from the terminal. Even if only the contents data is restored, the reading is refused in the contents authentication.

Explanation about the contents signature and the contents authentication will be supplemented. If the contents is written into the storing device of the large capacity, the authentication value of the contents for the alteration detection is recorded into the non-volatile memory by the contents signature and the apparatus is set into the readable state. Even if the contents in which the contents signature is not made exists, such contents is the contents which cannot be read out. In the reading process, it is preliminarily confirmed by the contents authentication that the contents data is not altered by the fact that the authentication value of the contents coincides with the authentication value in the non-volatile memory, so that the reading of the contents is permitted. Since the dividing and coupling processes include the foregoing processes of both of the reading and the writing of the contents, the previous contents authentication and the post contents signature are accompanied.

In this manner, when the contents data is written and read out, the contents signature and the contents authentication are performed and the alteration detection can be performed. By the management of the session, the contents signature can be made to the contents data in which the process has been finished as abnormality on the way of the session and the contents signature has not been made. By the alteration detection, for example, the following situation is avoided: the data of the contents by which a copy media or a file in which the contents has been written before and which is authenticated in terms of copyright protection because the moving process has already been executed is restored, so that the contents data can be read out again. This is because if such a data reading is possible, such critical infringement of the copyright that a large quantity of copy media or files which are authenticated in terms of copyright protection are formed for one copy-once contents is permitted.

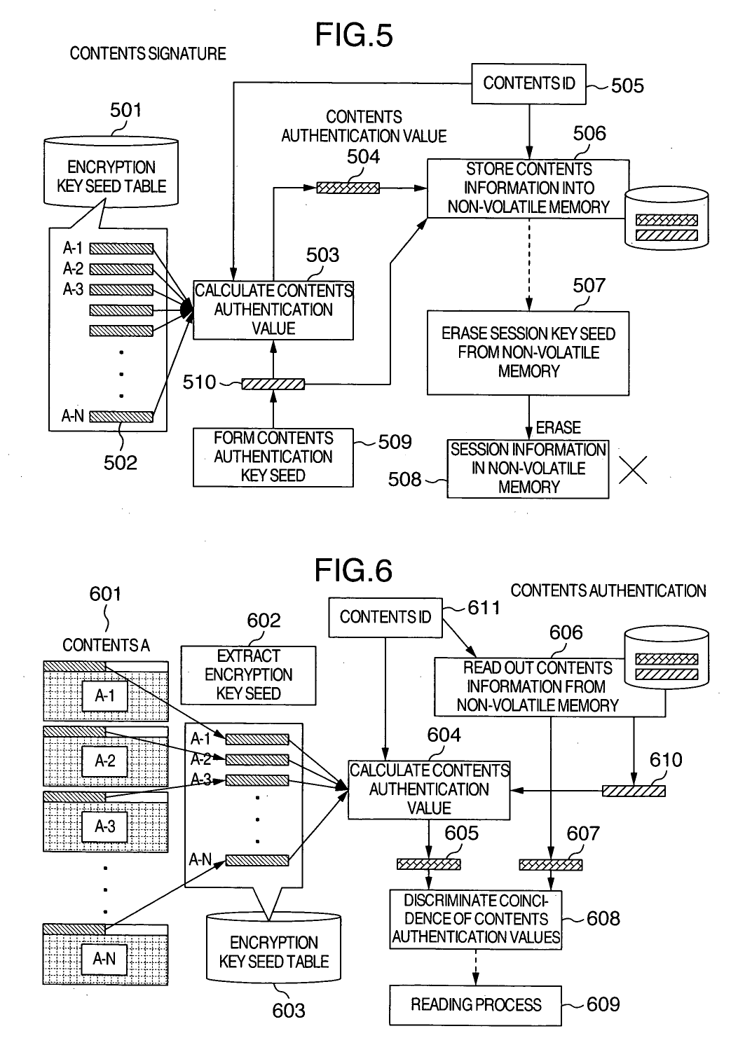

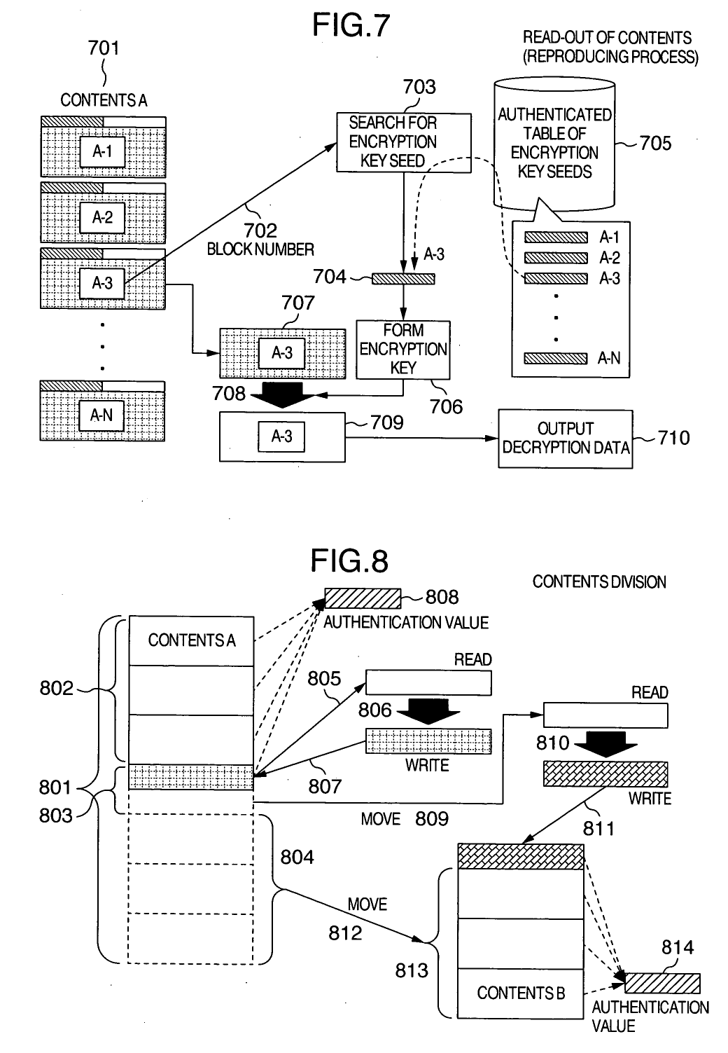

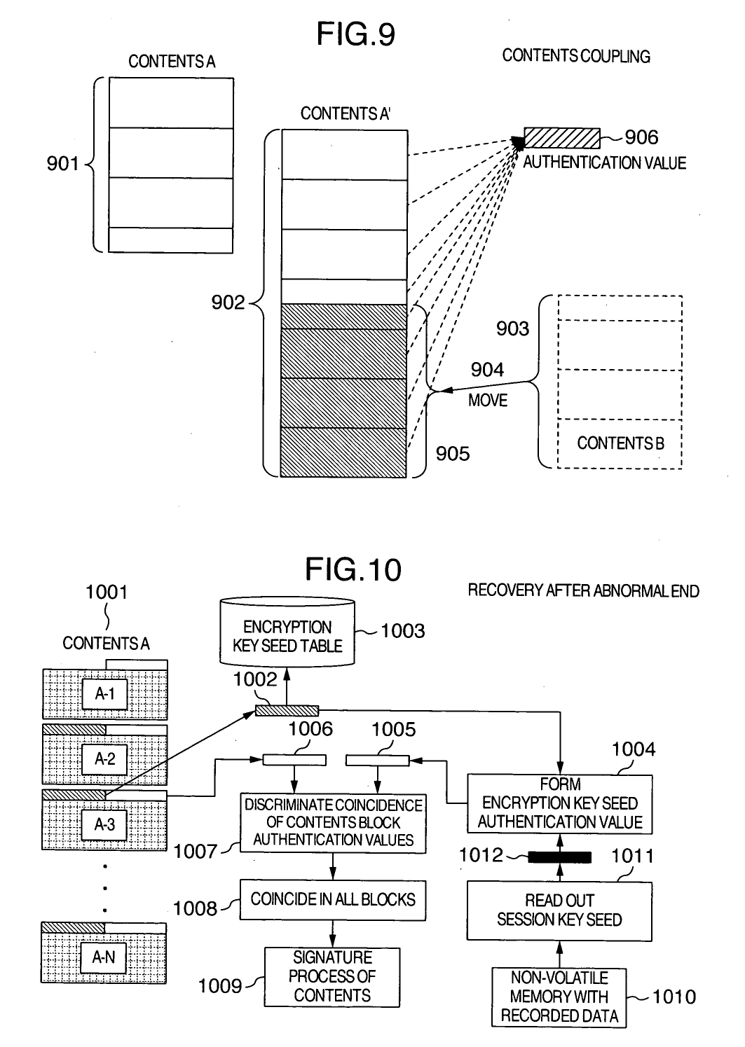

The contents writing process will be explained in detail with reference to FIG. 4. The contents signature process will be explained in detail with reference to FIG. 5. The contents authenticating process will be explained in detail with reference to FIG. 6. The contents reading process will be explained in detail with reference to FIG. 7. The contents dividing process will be explained in detail with reference to FIG. 8. The contents combining process will be explained in detail with reference to FIG. 9. The abnormality restoring process will be explained in detail with reference to FIG. 10.

FIG. 4 shows an embodiment of the invention explaining the writing process of the contents. Together with the encryption of the contents, information with which the contents alteration can be detected by using the abnormal end of the session is formed.

Prior to the contents writing process, a session key seed 402 is formed by using the random number generating function in 401 and recorded into a non-volatile memory 403. When the contents data is inputted in 404, the contents is divided on a unit basis of, for example, a duration of one minute in 405. An encryption key seed 408 is formed by using the random number generating function in 407. The encryption key seed 408 is stored in an encryption key seed table 417. An authentication value 414 of the contents block is formed in 413 by using the terminal unique information, session key seed 402, and encryption key seed 408. An encryption key is formed in 410 from the terminal unique information and the encryption key seed 408. An encrypting process 411 is performed to a contents block 406 divided in 405. The encrypted contents block is stored into the storing device of the large capacity in 412. In this instance, the encryption key seed 408 is stored into the storing device of the large capacity in 409 and the contents block authentication value 414 is stored into the storing device of the large capacity in 415. In this manner, contents data 416 is written (recorded) into the storing device of the large capacity. The processes in a range from the encrypting process 411 to the data storage 412 may be successively executed instead of the block unit basis. Although the contents block authentication value 414 is formed by using the encryption key seed 408, the contents block itself which is stored in 412 may be also used.

Besides the random numbers, numerical value information which is counted up each time the seed is formed is included in the encryption key seed and the session key seed. Therefore, the same key seed is never formed. Since the terminal unique information is included besides the key seed upon creation of the encryption key and the authentication value, the same encryption key and the same authentication value are not formed in another terminal.

Although the input of the terminal unique information is not shown in the diagram, it is assumed that it has actually been inputted in the creation 413 of the contents block authentication value and the creation 410 of the encryption key. It is assumed that the terminal unique information has been inputted in all of the creation of authentication values and the creation of the encryption keys, which will be explained hereinbelow, although there is no explanation. As terminal unique information, a serial number of the product, a unique number corresponding thereto, or the like can be used.

In this manner, the different encryption key is formed every contents block on the basis of the terminal unique information and the encryption can be performed. By using the session key seed 402, the encryption key seed 408 serving as an origin of the encryption key or the contents block authentication value with which the alteration of the encrypted contents block can be detected can be formed.

FIG. 5 shows an embodiment of the invention explaining the contents signature. After the storage of the contents into the storing device of the large capacity is finished by the writing process of the contents, the contents signature is executed in order to form the information with which the contents alteration can be detected.

Reference numeral 501 denotes an encryption key seed table shown at 417 in FIG. 4. Encryption key seeds 502 have been stored in the table 501 in a form corresponding to each block of the contents. First, a contents authentication key seed 510 including the random numbers is formed in 509. A Hash arithmetic operation is executed in 503 to all of the encryption key seeds 502, the contents ID 505, the contents authentication key seed 510, and the terminal unique information, so that a contents authentication value 504 is formed. In 506, together with the contents ID 505 corresponding to the contents, the contents authentication value 504 and the contents authentication key seed 510 are recorded as contents information into a non-volatile memory 508 which cannot be accessed from the outside. In the case where the contents information has normally been recorded, the session key seed recorded in the non-volatile memory before the writing process is erased in 507. If a size of contents is small or a data processing speed is sufficiently high, the calculation of the contents authentication value may be also executed to the whole contents instead of the encryption key seed table.

By setting the result of the Hash arithmetic operation to the encryption key seed to the contents authentication value in this manner, the process is completed at a speed higher than that upon calculation of the authentication value of the whole contents. By erasing the session key seed, use of the same session key seed after the end of the session is prevented.

Since the contents ID, contents authentication key seed, and terminal unique information are used to calculate the contents authentication value, the contents authentication value becomes a value unique to the contents due to the contents ID, becomes a different value even for the same contents due to the contents authentication key seed including the random numbers, and becomes a value which differs every terminal due to the terminal unique information. Thus, the alteration by the replacement of the contents or the estimation of the calculating method of the contents authentication value is made difficult.

If the life of the number of writing times or the number of erasing times of the non-volatile memory at the presumed maximum use frequency is sufficiently longer than the product life, the contents authentication value to be recorded into the non-volatile memory may be also updated each time the contents block authentication value during the contents writing operation in FIG. 4 is formed. If the life of the non-volatile memory is not sufficiently longer than the product life, the life of the non-volatile memory can be prolonged by making the contents signature only once after the contents was written by the method shown in FIGS. 4 and 5.

In the case of the memory such as a flash ROM whose erasing unit is large among the non-volatile memories, there is a fear that all of the data of the block as an erasing unit is lost by the power-off during the erasing process. Therefore, the risk of the data loss due to the power-off can be reduced by decreasing a frequency of the block erasure by the method shown in FIGS. 4 and 5.

FIG. 6 shows the embodiment of the invention explaining the contents authentication. Prior to executing the reading process (reproduction) of the contents, the contents authentication is made to detect the alteration of the contents stored in the storing device of the large capacity.

Reference numeral 601 denotes contents data. The contents has been divided into blocks on a unit basis of, for example, a duration of one minute of the contents and the divided blocks have been encrypted by different encryption keys. In 602, the encryption key seed is extracted from each block of the contents and stored into an encryption key seed table 603. In 606, the contents information corresponding to a contents ID 611 of the contents is read out of the non-volatile memory. A contents authentication value 607 and a contents authentication key seed 610 are read out as contents information. In 604, a contents authentication value 605 is calculated by a Hash arithmetic operation from all of the encryption key seeds in the encryption key seed table 603, the contents ID 611, the contents authentication key seed 610, and the terminal unique information. Whether or not the contents authentication value 607 included in the contents information coincides with the contents authentication value 605 is discriminated in 608. If they coincide, it is determined that there is no alteration, and the processing routine advances to a reading process 609. When the contents authentication value is calculated, it is necessary to use a method whereby the same value as that upon contents signature in FIG. 5 can be calculated.

By the above method, the contents alteration until the contents data is again read out after it was written into the storing device of the large capacity can be detected. If it is detected, the reading process of the contents data is inhibited, so that the infringement of the copyright can be prevented. Since the illegal contents reading can be refused prior to actually executing the decrypting process of the contents data, the discrimination about the illegality can be made at a high speed.

FIG. 7 shows the embodiment of the invention explaining the reading process of the contents. The encryption of the authenticated contents is decrypted.

Reference numeral 701 denotes contents data. A situation where the reading process of the third contents block (A-3) is being executed is shown. When a block number is notified in 702, an encryption key seed 704 of the corresponding block is read out of an authenticated table of encryption key seeds 705 in 703. An encryption key is formed by using the terminal unique information and the encryption key seed in 706. A contents block 707 is decrypted in 708, so that non-encrypted data in 709 is formed and outputted to the display/speakers or the like in 710. The processes from the decrypting process 708 of the encryption to the data output in 710 may be successively executed instead of the block unit basis.

In the case of the moving process of the contents, after the contents block was read out, by erasing the encryption key seed included in 701 (or the encrypted encryption key) or erasing the contents block itself, the reproduction of the moved data is prevented. After completion of the movement of all of the contents blocks, the contents information including the corresponding contents authentication value is erased from the non-volatile memory or the moved recording data can be also stored.

As mentioned above, by using the encryption key seed which has been authenticated by the contents authentication and read out of the encryption key seed table instead of forming the encryption key by using the encryption key seed included in the contents 701, the contents alteration for a period of time until the contents data is outputted after the contents authentication can be prevented.

In FIGS. 4 to 7, the encryption key seed is used as original data to form the encryption key and the authentication value of the encryption key seed has been calculated in order to detect the alteration of the contents block unit. In place of the encryption key seed, the encryption key obtained by further encrypting the encryption key itself may be also used. The contents block authentication value can be also obtained by using the whole contents block in place of using the encryption key seed. Further, the authentication value in the encryption key seed table is used as a contents authentication value. The authentication value of the whole contents may be also used in place of the authentication value in the encryption key seed table.

FIG. 8 shows the embodiment of the invention explaining the contents division. The contents division in the editing operation is performed and one contents is divided into two contents. Although not shown, since the contents division is accompanied with the reading and writing processes of the contents, the processes of the previous contents authentication and the post contents signature are executed.

Reference numeral 801 denotes the whole of one contents data; 802 blocks in which the whole block remains in the original contents; and 803 a block in which one block is constructed by both of the original contents and the contents of a dividing destination. A portion included in the original contents is read out of the block 803 as shown in 805. A decrypting process of the original encryption and an encrypting process by the encryption key seed which has newly been formed are executed in 806. A writing process is executed in 807. An authentication value 808 is calculated for the blocks 802 and the block which has newly been written in 807 and set to a contents authentication value. By storing such a value into the non-volatile memory by the contents signature, the contents which can be read out is obtained.

The portion 803 which is moved to the dividing destination is read out in 809. A decrypting process of the original encryption and an encrypting process by the encryption key seed which has newly been formed are executed in 810. The writing process is executed in 811. Since the encryption key seed formed in 806 and that in 810 differ, different encrypting processes are executed to both of them. Reference numeral 804 denotes blocks in which the whole block is moved to the dividing destination. The blocks are moved in 812. Data is written subsequently to the data written in 811. An authentication value 814 is calculated for the block which has newly been written in 811 and blocks 813 and set to the contents authentication value. By storing such a value into the non-volatile memory by the contents signature, the two contents become the new contents which can be read out. In this instance, it is necessary to erase the authentication value of the original contents.

As mentioned above, since the information depending on the contents is not used when the encryption key to encrypt the contents block is formed, with respect to the block in which the whole contents block is used as it is, even if the contents block is embedded into a part of another contents, the decrypting process of the encryption and the re-encrypting process are not accompanied. Therefore, even if there is a large quantity of data, a processing load can be reduced and the editing process can be executed at a high speed.

Since the information depending on the contents is not used when the encryption key is formed, even if a part of the contents is replaced or added by using the block of another contents written at the same terminal, the data in such a portion can be decrypted in principle. Therefore, in order to prevent the infringement of the copyright using such data, the contents signature and the contents authentication shown in FIGS. 5 and 6 are the indispensable processes.

Although the contents blocks of the dividing destination of the latter half of the whole contents data 801 are erased, even if the data is restored, it is not included in the calculation of the contents authentication value. Therefore, when the contents authentication is executed, if such a portion is included in the contents authentication, the contents authentication value differs from the value recorded in the non-volatile memory and its reading is refused. In this manner, such an alteration that the data which has already been moved by the contents division can be read out again can be prevented.

FIG. 9 shows the embodiment of the invention explaining the contents coupling. The contents coupling of the editing operation is executed and two contents are coupled into one contents. Although not shown, since the contents coupling is accompanied with the reading and writing processes of the contents, the processes of the previous contents authentication and the post contents signature are executed.

Reference numerals 901 and 903 denote two contents. Subsequent to the contents 901, the contents 903 is moved in 904 and coupled as shown at 905. The two contents become one contents such as 902. A contents authentication value 906 is calculated for all blocks. By storing the contents authentication value 906 into the non-volatile memory by the contents signature, the contents becomes the new contents which can be read out. In this instance, it is necessary to erase the authentication value of the original contents.

As mentioned above, with respect to the blocks in which the whole contents block is used as it is, since the decrypting process of the encryption and the re-encrypting process are not accompanied in a manner similar to FIG. 8, even if there are a large quantity of data, the processing load can be reduced and the editing process can be executed at a high speed. The alteration of the contents can be prevented and the coupling process of the contents can be executed.

By combining the process for dividing one contents into two contents in FIG. 8 and the process for forming one contents by coupling two contents, the process for dividing one contents into a plurality of contents and the process for forming one contents by coupling a plurality of contents can be realized. A plurality of contents can be also patched with another plurality of contents like a collage.

As another embodiment, in the method of using the information depending on the contents when the encryption key to encrypt the contents block is formed, for example, in the case of forming one contents by coupling two contents, it is also possible to construct in such a manner that the encryption blocks by the encryption key depending on the different contents are coupled as they are and can be handled as one contents in which the encrypted contents blocks depending on a plurality of contents have ideally been coupled. Although such one contents is substantially constructed by two contents and it is necessary to decrypt them by using each key, the signature and the authentication of the contents in which the high-speed process can be executed are executed as one contents, so that they can be coupled as one contents without executing the decryption and encryption. Therefore, the processing speed is raised. It can be considered that the processes of the contents signature and authentication which have been performed to the contents blocks mentioned above are expanded to the contents itself.

FIG. 10 shows the embodiment of the invention explaining the recovery process after an abnormal end. When the process is abnormally finished due to the power-off or the like on the way of the writing process of the contents, the contents signature can be made while detecting the contents alteration by this process.

Reference numeral 1001 denotes contents data and the situation where the process is being executed to the third contents block (A-3) is shown. First, in 1011, a session key seed 1012 is read out of a non-volatile memory with recorded data 1010. An encryption key seed 1002 is read out of the third contents block (A-3) and stored into an encryption key seed table 1003. A contents block authentication value 1005 is calculated from the session key seed 1012, the encryption key seed 1002, and the terminal unique information in 1004. A contents block authentication value 1006 is read out of the contents block (A-3) and whether or not the contents block authentication value 1005 coincides with the contents block authentication value 1006 is discriminated in 1007. If the contents block authentication values coincide in all blocks included in the contents 1001 in 1008, the contents signature process is executed by using the encryption key seed table 1003 in 1009. If they differ in at least one block, it is regarded that the data has been altered, and the process is stopped. Although the contents block authentication value 1005 has been formed by using the encryption key seed 1002, the contents block (A-3) itself may be used.

As mentioned above, in the case of the method of executing the contents signature process only once after the contents was written, there is considered such illegality that the power-off or the like is caused during the contents writing process and the contents blocks are replaced during such a power-off, thereby enabling the moving process to be executed an infinite number of times. However, according to the invention, since the alteration is detected by the contents block authentication value, such critical infringement of the copyright can be prevented.

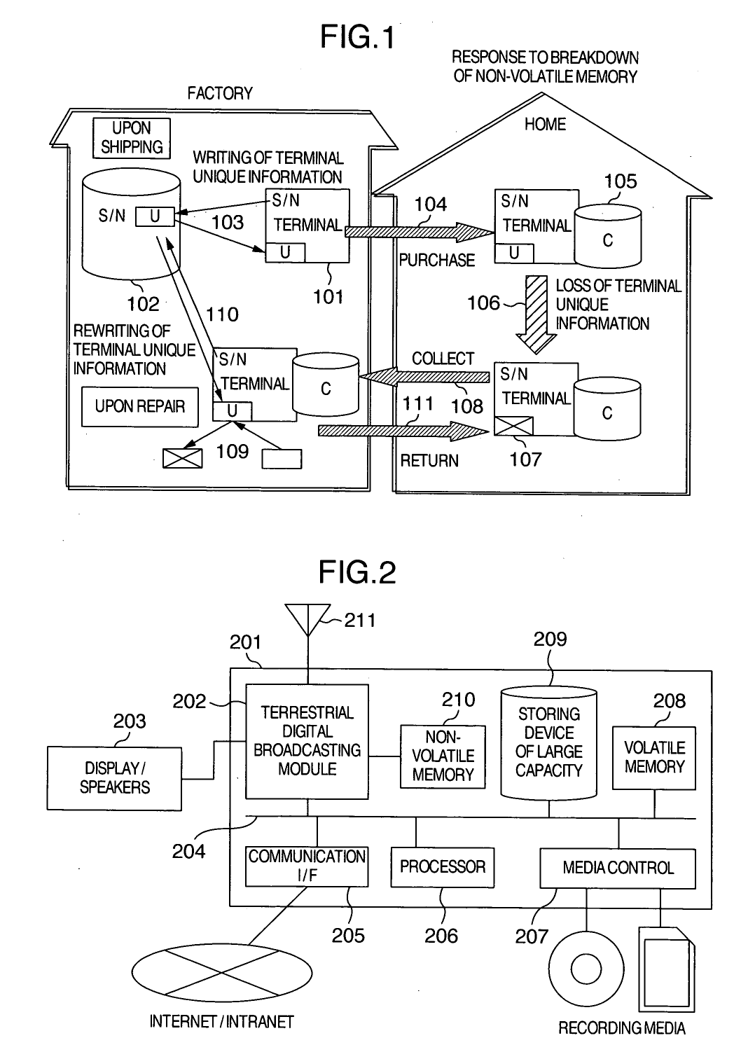

FIG. 1 shows the embodiment of the invention explaining a repairing method for a loss of the terminal unique information or a breakdown of the non-volatile memory. If the terminal-unique information is lost or the non-volatile memory is broken, the same contents authentication value as that upon contents signature cannot be restored, the same encryption key as that upon contents writing cannot be restored, or the contents authentication is refused. Anyway, the stored contents cannot be reproduced. The invention describes a method of enabling the stored contents to be reproduced by the collection repair.

Reference numeral 101 denotes a terrestrial digital broadcast receiving terminal having a serial number (S/N) and a non-volatile memory; and 102 indicates a database in which the S/N and terminal unique information (U) corresponding thereto have been stored. The terminal unique information (U) corresponding to the S/N is stored into the non-volatile memory of the terminal in 103 upon shipping from the factory. For example, when the terminal is purchased at home in 104 and the contents is recorded, written contents (C) 105 is stored in a storing device of a large capacity in the terminal. However, if the terminal unique information is lost or the non-volatile memory itself is broken (106), the stored contents cannot be reproduced. To repair a non-volatile memory 107 having such inconveniences, the terminal is collected to the factory. If the non-volatile memory in the terminal collected to the factory has been broken, the non-volatile memory is exchanged in 109. Subsequently, the terminal unique information corresponding to the serial number (S/N) is read out (110) by accessing the database 102 and the same value as that upon shipping from the factory is written again into the non-volatile memory 210. When the non-volatile memory is exchanged, since the contents authentication information has also been lost, the contents signature process is forcedly executed to all of the contents stored in the storing device of the large capacity, thereby forming the contents authentication information into the non-volatile memory. After that, the terminal is returned (111). Since correct values have been written as terminal unique information and contents authentication information into the returned terminal, the stored contents can be reproduced.

As mentioned above, even in the software-like loss of the terminal unique information or the hardware-like breakdown of the non-volatile memory, the apparatus can be returned to the state where the stored contents is reproduced again by coping with the collection repair.

Since each block is encrypted by using the encryption key which does not depend on the contents unique information and differs every block as mentioned above, in the editing operation of the contents, the division and coupling of the block unit basis can be executed without executing the decrypting process of the encryption and the re-encrypting process. In the case where the break line of the division, since it is sufficient to execute the decrypting process of the encryption and the re-encrypting process only for an interval from a break line of the division in the block to a boundary between the blocks is not the boundary between the blocks in the contents division, a processing amount can be remarkably reduced. Therefore, a speed of the editing operation is raised.

As a process during the contents writing operation, a Hash arithmetic operation is executed to all encryption keys existing every block, all of the encrypted encryption keys, all key seed data to form the encryption keys, or all Hash values calculated by executing the Hash arithmetic operation to the whole block and the obtained Hash arithmetic operation values are recorded into the non-volatile memory which cannot be accessed from the outside. As a process before the contents is read out, the result obtained by executing the similar Hash arithmetic operation is compared with the Hash values recorded in the non-volatile memory and whether or not they coincide is discriminated. Therefore, even if a part of the contents has been replaced by a part of another contents or a part of another contents is added due to the alteration, such alteration of the contents is detected or the illegal encryption decryption regarding the altered portion can be prevented. Therefore, since the apparatus cannot be set into the removable state again by replacing a part of the contents by a part of the contents which has already been moved or adding such a part of the contents, the critical infringement of the copyright which is caused by the creation of a large quantity of copies can be prevented.

Since the updating of the Hash value for the periodic contents is not performed during the process of the contents writing operation, a frequency of the writing into the non-volatile memory is low, so that a risk that the life expires because the number of writing times exceeds the limit value is low. On the contrary, when the power source is turned off during the process, since the Hash value for the contents is not recorded in the non-volatile memory, the reading process of the contents is inhibited. Thus, the apparatus is provided with the recovery process for recovering from the power-off upon activation of the information apparatus and enabling the information up to the portion where the contents could be written to be reproduced.

Since the Hash arithmetic operation is executed by using the session key unique to the one writing process and the Hash arithmetic operating method using the session key is made secret, substantially the same value as the Hash value which is calculated in the information apparatus cannot be calculated by using the same session key for a part of another contents. Therefore, in the case where the power source is turned off as an illegal process and the contents has been replaced by a part of another contents or a part of another contents has been added, such a situation that the contents which was illegally altered is used as formal contents and the Hash value is registered can be prevented by the recovery process. A time interval during which the illegality that is caused by the updating of the Hash value due to the periodic time interval is permitted does not exist either. Therefore, since the apparatus cannot be set into the removable state by replacing a part of the contents by a part of the contents which has already been moved or adding such a part of the contents, the critical infringement of the copyright which is caused by the creation of a large quantity of copies can be prevented.

The invention is not limited to the foregoing embodiment but many modifications are possible within the scope of the invention without departing from the spirit thereof. Further, various inventions are included in the foregoing embodiment and the various inventions can be extracted by a proper combination of a plurality of component elements which are disclosed. For example, in the case where at least one of the problems mentioned in “Problem to be solved by the Invention” can be solved even if several ones of the component elements shown in the embodiment are deleted, a construction in which those component elements are deleted becomes the invention.

1. An information processing apparatus for processing contents, comprising:
a receiving unit which receives the contents constructed on a block unit basis;
a contents dividing unit which divides the contents received by said receiving unit on the basis of the block unit;
a forming unit which formes block unique information as unique information corresponding to each block of said contents divided by said contents dividing unit;
a storing unit which stores apparatus unique information to specify said information processing apparatus; and
a control unit which controls so as to store a Hash value of data constructed by said block unique information formed by said forming unit and said apparatus unique information stored by said storing unit into said storing unit.

2. An apparatus according to claim 1, further comprising a Hash value calculating unit which calculates the Hash value by using said block unique information and said apparatus unique information.

3. An apparatus according to claim 1, wherein said block unique information includes an encryption key of the block of the contents.

4. An apparatus according to claim 3, wherein the encryption key of said block is further encrypted.

5. An apparatus according to claim 1, wherein said block unique information is encryption key seed data including random numbers serving as an origin to form an encryption key of said block.

6. An apparatus according to claim 1, further comprising:
a division contents storing unit which stores the contents divided by said contents dividing unit; and
a contents authenticating unit which makes authentication by using a Hash value of said division contents and said Hash value stored by said storing unit in the case of reproducing the division contents stored by said division contents storing unit.

7. An apparatus according to claim 6, wherein said contents authenticating unit compares the Hash value of said division contents with said Hash value stored by said storing unit, thereby discriminating whether or not they coincide.

8. An apparatus according to claim 1, further comprising a contents coupling unit which couples at least two or more of said contents, and
wherein in the case of coupling said contents by said contents coupling unit, said control unit controls so as to store a Hash value which is formed from the Hash value corresponding to data coupled by said coupling unit and said apparatus unique information into said storing unit.

9. An information processing apparatus for processing contents, comprising:
an input unit which inputs the contents constructed on a block unit basis;
a contents storing unit which stores the contents inputted to said input unit;
a contents reproducing unit which reproduces the contents stored by said contents storing unit;
a contents dividing unit which divides the contents received by a receiving unit on the basis of the block unit;
a block unique information forming unit which formes block unique information as information unique to the block of said contents divided by said contents dividing unit; and
a control unit which integratedly controls said information processing apparatus,
wherein in the case of dividing the contents by said contents dividing unit, said control unit obtains a Hash value by using said block unique information formed by said block unique information forming unit.

10. An information processing method for an information processing apparatus which can process contents, comprising the steps of:
inputting the contents constructed on a block unit basis;
dividing said inputted contents on the basis of the block unit;
forming block unique information as unique information corresponding to each block of said divided contents;
storing apparatus unique information to specify said information processing apparatus; and
storing a Hash value of data constructed by said formed block unique information and said apparatus unique information stored into a storing unit.
